(19) United States
(12) Patent Application Publication
(10) Pub. No.: US 2024/0149741 A1
(43) Pub. Date: May 9, 2024

(54) BATTERY TRANSPORT SUPPORT SYSTEM, BATTERY TRANSPORT SUPPORT DEVICE, BATTERY TRANSPORT SUPPORT METHOD, AND STORAGE MEDIUM STORING BATTERY TRANSPORT SUPPORT PROGRAM

(71) Applicant: HONDA MOTOR CO., LTD., Tokyo (JP)

(72) Inventors: Kotaro NAKAMURA, Tokyo (JP); Yusuke NAKAJIMA, Tokyo (JP); Michiyo INOUE, Tokyo (JP); Hiroshi MORIYAMA, Tokyo (JP); Kentaro SUGIMURA, Saitama (JP)

(73) Assignee: HONDA MOTOR CO., LTD., Tokyo (JP)

(21) Appl. No.: 18/281,196

(22) PCT Filed: Mar. 11, 2021
(86) PCT No.: PCT/JP2021/009898

§ 371 Date: Sep. 8, 2023

(51) Int. Cl. B60L 53/80; B60L 53/65

(52) U.S. Cl. CPC B60L 53/80; B60L 53/65

(57) ABSTRACT

A battery transport support device (10) that comprises: a communication unit (11) that acquires charging batter information from a charging device (20), the charging batter information including identification information for batteries (BAT) being charged by the charging device (20); a specification unit (12) that references a storage unit (14) that stores identification information for users in association with identification information for batteries (BAT) that belong to the users and, on the basis of the charging battery information, specifies the number of batteries (BAT) included in the batteries (BAT) being charged by the charging device (20) that belong to one of the users; and a derivation unit (13) that, on the basis of the number of batteries (BAT) that belong to the one user and the number of batteries (BAT) that can be carried by transport devices, derives a transport device needed to transport the batteries (BAT) that belong to the one user to a transport destination that corresponds to the one user. The communication unit (11) outputs transport support information to a terminal device (30) of a charging business (X), the transport support information including information about the derived transport device needed.

### TECHNICAL FIELD

The present invention relates to a battery transport support system, a battery transport support device, a battery transport support method, and a battery transport support program.

### BACKGROUND ART

Patent Literature 1 discloses a technique in which a battery pack housed in a battery housing of an electric work vehicle includes a battery unit, a battery case in which the battery unit is housed, and a plurality of anti-vibration members positioned between the battery case and the battery unit to prevent vibration of the battery unit. Patent Literature 2 discloses a technique in which, when a plurality of batteries are simultaneously carried, a tip of a handle of a battery pack is fitted into a handle housing recess provided in an upper surface of another battery pack so that the two battery packs can be coupled to each other.

### CITATION LIST

### Patent Literature

Patent Literature 1: JP2018-011574A
Patent Literature 2: JP2008-105638A

### SUMMARY OF INVENTION

### Technical Problem

A charging service is conceivable in which, instead of a user, a charging operator charges a battery of the user and transports the battery to a destination (for example, a destination specified by the user) according to the user. When the charging operator provides such a charging service to the user, from the viewpoint of improving the service quality, it is desired that the charging operator efficiently transports the battery of the user to a destination.

The present invention provides a battery transport support system, a battery transport support device, a battery transport support method, and a battery transport support program that support battery transport by a charging operator who charges batteries of users and transports the batteries to a destination according to the users, and enable the charging operator to efficiently transport the batteries of the users to the destinations corresponding to the users.

### Solution to Problem

A first aspect of the present invention provides a battery transport support system for supporting battery transport by a charging operator who charges batteries of each user and transports the batteries to a destination according to each user, the battery transport support system including:
a charging device configured to charge the attached batteries and acquire identification information of the batteries from the batteries; and
a battery transport support device configured to acquire, from the charging device, charged battery information including the identification information of the batteries charged by the charging device, in which
the battery transport support device includes:
   a specifying unit configured to specify, based on the charged battery information acquired from the charging device, the number of batteries of one user included in the batteries charged by the charging device with reference to a storage unit that stores identification information of each user and identification information of the batteries of each user in association with each other,
   a derivation unit configured to derive, based on the number of batteries of the one user and the number of batteries capable of being loaded on each transport device, a transport device required to transport the batteries of the one user to a destination according to the one user, and
   an output unit configured to output, to a terminal device of the charging operator, transport support information including information on the transport device required to transport the batteries to the destination according to the one user.

A second aspect of the present invention provides a battery transport support device for supporting battery transport by a charging operator who charges batteries of each user and transports the batteries to a destination according to each user, the battery transport support device being configured to acquire, from a charging device that charges the attached batteries and acquires identification information of the batteries from the batteries, charged battery information including the identification information of the batteries charged by the charging device, the battery transport support device including:
a specifying unit configured to specify, based on the charged battery information acquired from the charging device, the number of batteries of one user included in the batteries charged by the charging device with reference to a storage unit that stores identification information of each user and identification information of the batteries of each user in association with each other;
a derivation unit configured to derive, based on the number of the batteries of one user and the number of batteries capable of being loaded on each transport device, a transport device required to transport the batteries of the one user to a destination according to the one user; and
an output unit configured to output, to a terminal device of the charging operator, transport support information including information on the transport device required to transport the batteries to the destination according to the one user.

A third aspect of the present invention provides a battery transport support method for supporting battery transport by a charging operator who charges batteries of each user and transports the batteries to a destination according to each user, the method including:
a computer configured to acquire, from a charging device that charges the attached batteries and acquires identification information of the batteries from the batteries, charged battery information including the identification information of the batteries charged by the charging device executing the processing of:
specifying, based on the charged battery information acquired from the charging device, the number of batteries of one user included in the batteries charged by the charging device with reference to a storage unit that stores identification information of each user and identification information of the batteries of each user in association with each other;
deriving, based on the number of batteries of the one user and the number of batteries capable of being loaded on each transport device, a transport device required to transport the batteries of the one user to a destination according to the one user; and
outputting, to a terminal device of the charging operator, transport support information including information on the transport device required to transport the batteries to the destination according to the one user.

A fourth aspect of the present invention provides a battery transport support program for supporting battery transport by a charging operator who charges batteries of each user and transports the batteries to a destination according to each user, the program causing a computer configured to acquire, from a charging device that charges the attached batteries and acquires identification information of the batteries from the batteries, charged battery information including the identification information of the batteries charged by the charging device to execute processing including:
specifying, based on the charged battery information acquired from the charging device, the number of batteries of one user included in the batteries charged by the charging device with reference to a storage unit that stores identification information of each user and identification information of the batteries of each user in association with each other;
deriving, based on the number of batteries of the one user and the number of batteries capable of being loaded on each transport device, a transport device required to transport the batteries of the one user to a destination according to the one user; and
outputting, to a terminal device of the charging operator, transport support information including information on the transport device required to transport the batteries to the destination according to the one user.

### Advantageous Effects of Invention

According to the present invention, it is possible to provide a battery transport support system, a battery transport support device, a battery transport support method, and a battery transport support program that enable a charging operator who charges batteries of users and transports the batteries to a destination according to the users to efficiently transport the batteries of the users to a destination according to the users.

### BRIEF DESCRIPTION OF DRAWINGS

FIG. 1 is a diagram showing an outline of a charging service supported by a battery transport support system of the present embodiment.

FIG. 2 is a diagram showing an example of a battery transport support system of a first embodiment.

FIG. 3 is a diagram showing an example of charged battery information.

FIG. 4 is a diagram showing an example of a battery DB.

FIG. 5 is a diagram showing an example of a destination information DB.

FIG. 6 is a diagram showing an example of a transport device table.

FIG. 7 is a sequence diagram showing an example of processing executed by devices of the battery transport support system.

FIG. 8 is a flowchart showing an example of transport support information update processing.

FIG. 9 is a diagram showing an example of a transport support information display screen according to the first embodiment.

FIG. 10 is a diagram showing another example of the transport support information display screen according to the first embodiment.

FIG. 11 is a diagram showing an example of a battery transport support system according to a second embodiment.

FIG. 12 is a diagram showing an example of a transport support information display screen according to the second embodiment.

FIG. 13 is a diagram showing an example of alert information.

### DESCRIPTION OF EMBODIMENTS

Hereinafter, embodiments of a battery transport support system, a battery transport support device, a battery transport support method, and a battery transport support program of the present invention will be described with reference to the accompanying drawings. First, background circumstances and the like to which the battery transport support system, the battery transport support device, the battery transport support method, and the battery transport support program of the present embodiments are applied will be described.

For example, an operator, such as a landscaper, may regularly go to an apartment complex having a plurality of houses and a public space (for example, a lawn plaza) available to residents of the houses, and take care of (for example, lawn cutting) the public space. Generally, such an operator works using equipment such as a lawn mower. Therefore, the operator brings the equipment used for the work to the apartment complex, and if the equipment is electric equipment driven by a battery, the operator also brings the battery to the apartment complex to work. Then, when the work is finished, the operator brings back the used equipment or battery and charges the battery in preparation for the work of the next day.

Incidentally, the operator may work using a large number of batteries, and it takes a lot of labor and time for the operator to bring back these batteries after work and charge the batteries. Here, a charging service is conceivable in which, instead of a user such as an operator, a battery of the user is charged and the battery is transported to a destination (for example, an apartment complex where the operator works on the next day) according to the user. Hereinafter, an example of the charging service will be specifically described.

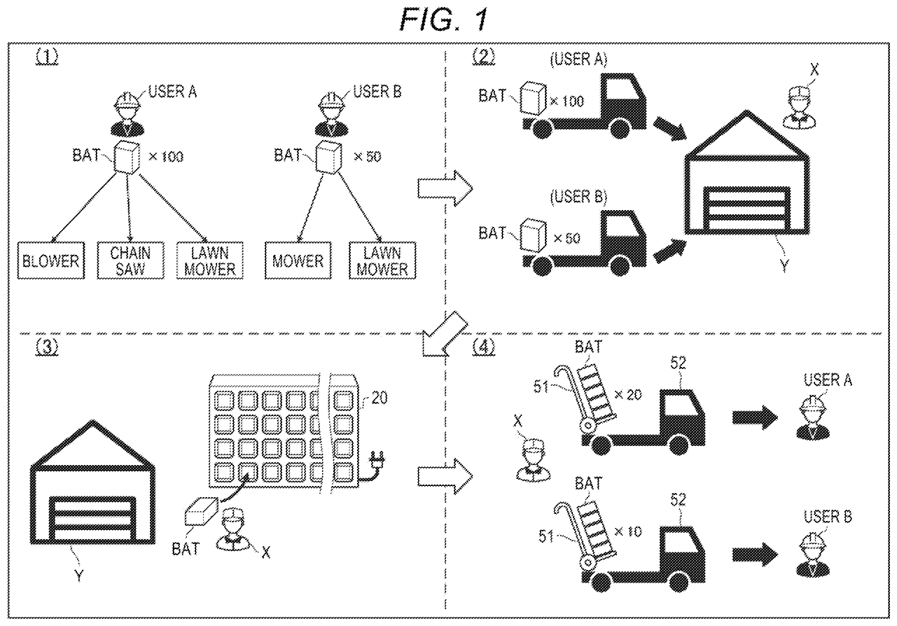

In FIG. 1, a user A is an operator who uses a hundred batteries BAT to drive electric equipment such as a blower, a chain saw, and a lawn mower and takes care of a public space of an apartment complex (see (1) of FIG. 1). The battery BAT is a power storage device that functions as a power source for driving the electric equipment when attached to the electric equipment, and is, for example, a secondary battery such as a lithium-ion battery or a nickel-hydrogen battery. The hundred batteries BAT used by the user A may be owned by the user A or may be rented to the user A by a charging operator X (to be described later) or the like.

In FIG. 1, a user B is an operator who uses fifty batteries BAT to drive electric equipment such as a mower and a lawn mower and takes care of a public space of an apartment complex (see (1) of FIG. 1). The fifty batteries BAT used by the user B may be owned by the user B or may be rented to the user B by the charging operator X or the like.

After using their respective batteries BAT (for example, after the work is finished), the user A and the user B bring the used batteries BAT to a business office Y of the charging operator X providing a charging service (see (2) of FIG. 1). The charging operator X may go to the user A and the user B to collect the respective batteries BAT in response to requests from the user A and the user B.

The charging operator X attaches the batteries BAT received from the user A and the user B to, for example, a charging device 20 installed in the business office Y and charges the batteries BAT (see (3) of FIG. 1). The charging device 20 may be installed at a place (for example, a warehouse of the charging operator X) different from the business office Y.

Then, after charging the hundred batteries BAT received from the user A, the charging operator X transports the hundred batteries BAT to a destination (for example, an apartment complex where the user A works using the batteries BAT) specified by the user A in advance (see (4) of FIG. 1). Similarly, after charging the fifty batteries BAT received from the user B, the charging operator X transports the fifty batteries BAT to a destination specified by the user B in advance (see (4) of FIG. 1).

Therefore, the user A and the user B can receive the batteries BAT charged by the charging operator X at a desired destination. In other words, the user A and the user B can reduce not only the time and effort of charging the batteries BAT but also the time and effort of transporting the batteries BAT to the destination.

Incidentally, the charging operator X uses a predetermined transport device such as a trolley 51 or a truck 52 to transport the batteries BAT. For example, the charging operator X first loads the batteries BAT charged by the charging device 20 on the trolley 51, and then loads the trolley 51 on the truck 52 for transport.

In the example shown in FIG. 1, each trolley 51 can load up to five batteries BAT, and each truck 52 can load up to thirty trolleys 51. Therefore, to transport the hundred batteries BAT received from the user A, the charging operator X divides and loads the hundred batteries BAT on twenty trolleys 51, and loads the twenty trolleys 51 on one truck 52 for transport. To transport the fifty batteries BAT received from the user B, the charging operator X divides and loads the fifty batteries BAT on ten trolleys 51, and loads the ten trolleys 51 on one truck 52 for transport.

For the charging operator X to efficiently transport the batteries BAT, it is necessary to appropriately select the transport device used for transport. However, when the number of batteries BAT of each user varies, the work of selecting an appropriate transport device becomes complicated. As the number of users and the number of batteries BAT increase, the work of selecting an appropriate transport device becomes more complicated. As a result, it becomes difficult for the charging operator X to efficiently transport the batteries BAT, and it may take time to transport the batteries BAT, resulting in a deterioration in the service quality of the charging service.

Here, the battery transport support system, the battery transport support device, the battery transport support method, and the battery transport support program of the present embodiment derive a transport device required to transport the batteries BAT of a user based on the number of batteries BAT of the user and the number of batteries BAT that can be loaded on each transport device, and output, to a terminal device of the charging operator X, transport support information including information indicating the user and the derived transport device.

As a result, the charging operator X can easily know the transport device required to transport the charged batteries BAT of the user, and can prepare the transport device. As a result, the charging operator X can efficiently and easily transport the charged batteries BAT of the user to a destination according to the user, and the service quality of the charging service can be improved.

Hereinafter, an example of a battery transport support system capable of supporting transport of the batteries BAT by the charging operator X providing the charging service shown in FIG. 1 will be described. In the following description, the same components are denoted by the same reference numerals, and redundant description thereof will be omitted or simplified as appropriate.

[Battery Transport Support System of First Embodiment]

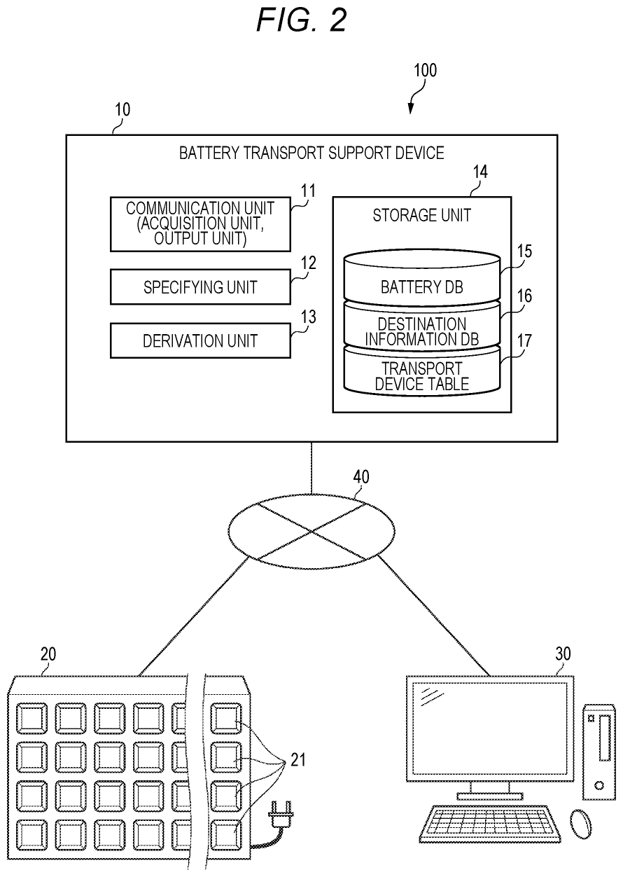

First, a first embodiment of the present invention will be described. As shown in FIG. 2, a battery transport support system 100 of the first embodiment includes a battery transport support device 10 and the charging device 20. In the battery transport support system 100, the battery transport support device 10 and the charging device 20 are communicably connected to each other via a network 40 such as the Internet. The battery transport support device 10 can also communicate with a terminal device 30 of the charging operator X via the network 40.

The charging device 20 is installed in a business office of the charging operator X and is configured such that the batteries BAT can be attached and detached. Here, the business office of the charging operator X may be, for example, the business office Y described above, but is not limited thereto. For example, the business office of the charging operator X may be a warehouse of the charging operator X. In this case, the charging operator X may bring the batteries BAT received from a user at the business office Y or the like to a warehouse where the charging device 20 is installed.

The charging device 20 includes, for example, a plurality of housing spaces 21 each capable of housing one battery BAT. Each housing space 21 includes a terminal (not shown) electrically connected to the battery BAT housed therein. The charging device 20 can charge the battery BAT housed in the housing space 21 and communicate with a control IC (hereinafter, also referred to as a battery IC) of the battery BAT housed in the housing space 21 via the terminal of the housing space 21.

By communicating with the battery IC, the charging device 20 can acquire information such as identification information (for example, a battery ID to be described later) and an output voltage of the battery BAT based on the battery IC. The charging device 20 generates charged battery information based on the information acquired based on the battery IC, and transmits the generated charged battery information to the battery transport support device 10. As a result, the battery transport support device 10 can acquire, from the charging device 20, the charged battery information including the identification information of the battery BAT charged by the charging device 20.

[Charged Battery Information]

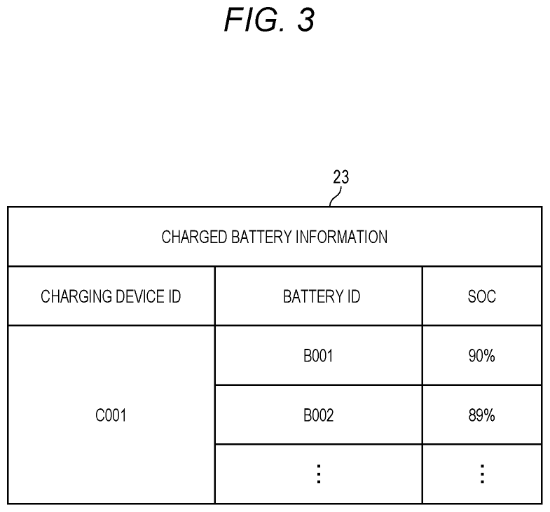

Here, an example of the charged battery information transmitted from the charging device 20 to the battery transport support device 10 will be described with reference to FIG. 3.

As shown in FIG. 3, charged battery information 23, which is an example of the charged battery information transmitted from the charging device 20 to the battery transport support device 10, includes the battery ID of the battery BAT charged by the charging device 20. Here, the battery ID is identification information for identifying the battery BAT. Therefore, the battery transport support device 10 can specify the battery BAT charged by the charging device 20 by referring to the charged battery information received from the charging device 20.

The charged battery information 23 further includes, for example, information on a charging device ID and a state of charge (hereinafter, also referred to as an SOC) of the battery BAT. Here, the charging device ID is identification information for identifying the charging device 20. Therefore, by referring to the charged battery information received from the charging device 20, the battery transport support device 10 can check which battery BAT is charged by which charging device 20, the SOC of the battery BAT being charged by the charging device 20, and the like.

For example, the charged battery information 23 shown in FIG. 3 indicates that the charging device 20 having a charging device ID “C001” charges the batteries BAT having a battery ID “B001”, a battery ID “B002”, and the like, the SOC of the battery BAT having the battery ID “B001” is 90%, and the SOC of the battery BAT having the battery ID “B002” is 89%.

In the example described here, the charged battery information includes the SOC information of the battery BAT, but the present invention is not limited thereto. For example, the charged battery information may include the information on the output voltage of the battery BAT instead of the SOC of the battery BAT. In this case as well, the battery transport support device 10 can acquire (derive) the SOC of the battery BAT based on the information on the output voltage of the battery BAT included in the charged battery information.

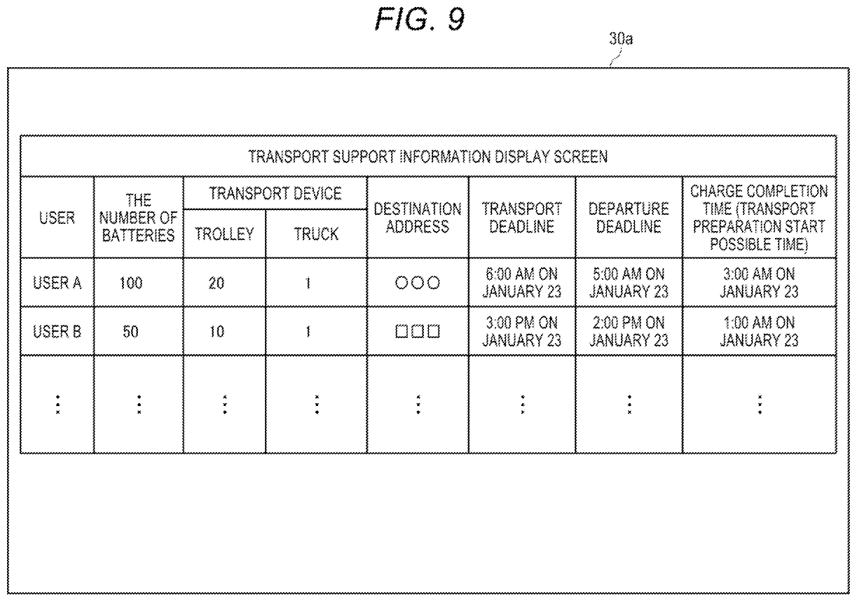

Returning to FIG. 2, the terminal device 30 is, for example, a personal computer (PC) installed in a business office (for example, the business office Y) of the charging operator X, and includes a display unit (for example, a liquid crystal display, see reference numeral 30a in FIGS. 9, 10, and 12) that displays various types of information and an input device (for example, a keyboard, a mouse, and the like) for receiving various types of operations. The terminal device 30 is not limited to a PC, and may be, for example, a smartphone or a tablet terminal of the charging operator X.

[Battery Transport Support Device]

The battery transport support device 10 is a server device (computer) including, for example, a processor (not shown), a storage device (not shown) such as a memory or a hard disk, and an interface (not shown) for controlling data input and output between the inside and the outside of the battery transport support device 10. An example of the battery transport support device 10 is a server device capable of communicating with the charging device 20 and the terminal device 30, but the present invention is not limited thereto. For example, the battery transport support device 10 may be provided integrally with the charging device 20 or the terminal device 30. That is, the battery transport support device 10 may be implemented by the charging device 20 or the terminal device 30 in which a predetermined program (for example, a battery transport support program to be described later) is installed. In this case, a processor of the charging device 20 or the terminal device 30 executes a program installed therein, so that the charging device 20 or the terminal device 30 can function as the battery transport support device 10.

The battery transport support device 10 includes, for example, a communication unit 11, a specifying unit 12, a derivation unit 13, and a storage unit 14. The storage unit 14 is implemented by, for example, a storage device such as a hard disk included in the battery transport support device 1, and stores a battery database (DB) 15, a destination information DB 16, and a transport device table 17. The DBs and the table may be constructed in advance by an administrator or the like of the battery transport support device 10, and may be appropriately updated by the battery transport support device 10.

[Battery DB]

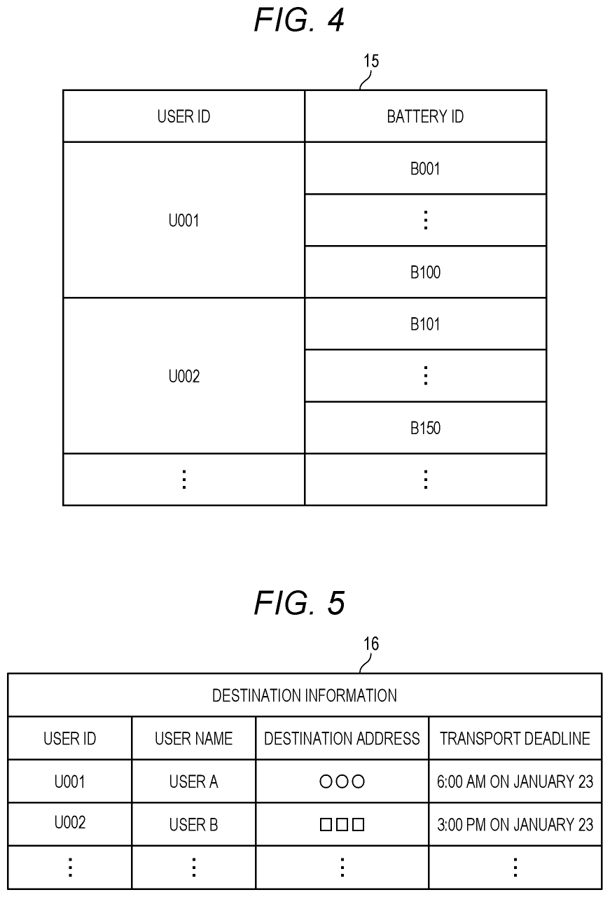

As shown in FIG. 4, the battery DB 15 stores a user ID for identifying a user who uses the charging service of the charging operator X and a battery ID of the battery BAT of the users in association with each other. For example, in FIG. 4, battery IDs “B001” to “B100” are associated with a user ID “U001”. This indicates that the batteries BAT corresponding to the battery IDs “B001” to “B100” are the batteries BAT of a user (for example, the user A shown in FIG. 1) with the user ID “U001”.

In FIG. 4, battery IDs “B101” to “B150” are associated with a user ID “U002”. This indicates that the batteries BAT corresponding to the battery IDs “B101” to “B150” are the batteries BAT of a user (for example, the user A shown in FIG. 1) with the user ID “U002”.

[Destination Information DB]

As shown in FIG. 5, the destination information DB 16 stores destination information in which, for example, a user ID, a user name, a destination address, and a transport deadline are associated with one another. For example, in FIG. 5, the destination address of destination information corresponding to a user whose user ID is “U001” and whose user name is “∘∘∘” user A“is”, and the transport deadline is “6:00 AM on January 23”. This indicates that the user whose user ID is “U001” and whose user name is “user A” specifies that the batteries BAT thereof should be delivered to the address of “∘∘∘” by “6:00 AM on January 23” after being charged.

For example, when leaving the batteries BAT to the charging operator X, a user tells the charging operator X of a user ID and a user name thereof, a desired destination address, a desired transport deadline, and the like. The charging operator X operates the terminal device 30 to input the information told by the user to the terminal device 30. Then, the terminal device 30 transmits destination information including the input user ID, user name, destination address, transport deadline, and the like to the battery transport support device 10. The battery transport support device 10 registers the destination information received from the terminal device 30 in the destination information DB 16 in this manner. The battery transport support device 10 may appropriately delete the destination information for the completed transport from the destination information DB 16.

[Transport Device Table]

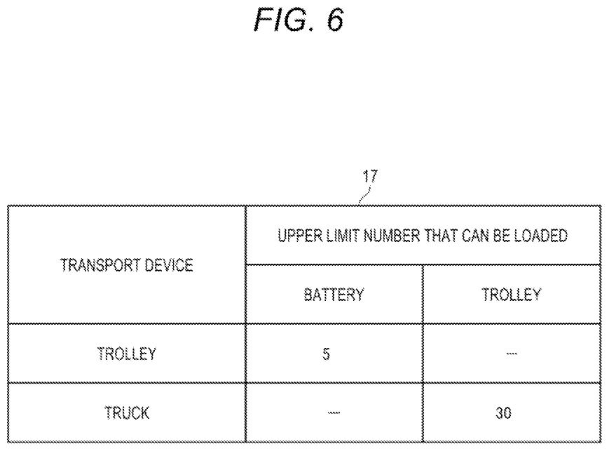

As shown in FIG. 6, the transport device table 17 stores an upper limit number of batteries BAT that can be loaded on each transport device. Here, the transport device includes, for example, the trolley 51 and the truck 52. The trolley 51 is a transport device on which the batteries BAT can be directly loaded, and can load up to a predetermined upper limit number (here, five as an example) of batteries BAT. The trolley 51 is an example of a first transport device.

The truck 52 is a transport device (that is, a transport device capable of indirectly loading the batteries BAT) capable of loading the trolley 51 on which the batteries BAT are loaded, and is capable of loading up to a predetermined upper limit number of trolleys 51 (here, thirty trolleys as an example). In other words, up to one hundred and fifty batteries BAT can be loaded on the truck 52. The truck 52 is an example of a second transport device.

[Functional Units of Battery Transport Support Device]

Returning to FIG. 2, functional Units included in the battery transport support device 10 will be described. The communication unit 11 is an example of a functional unit that functions as an acquisition unit (input unit) that acquires charged battery information from the charging device 20 and an output unit that outputs transport support information to the terminal device 30, transmits various types of information to the charging device 20 and the terminal device 30 via the network 40, and receives various types of information from the charging device 20 and the terminal device 30.

For example, as described above, the charging device 20 acquires the battery ID of the battery BAT by communicating with the battery IC of the battery BAT attached to the charging device 20, and transmits the charged battery information (for example, the charged battery information 23) including the information on the battery ID to the battery transport support device 10. The communication unit 11 acquires the charged battery information by receiving the charged battery information transmitted from the charging device 20 in this manner.

The specifying unit 12 specifies, based on the charged battery information acquired from the charging device 20 by the communication unit 11, the number of batteries BAT of one user included in the batteries BAT charged by the charging device 20 with reference to the storage unit 14. Specifically, the specifying unit 12 specifies the number of batteries BAT of the one user with reference to the battery DB 15 and the battery ID included in the charged battery information acquired from the charging device 20.

For example, the charged battery information acquired from the charging device 20 includes the battery IDs “B001” to “B100”. The battery IDs “B001” to “B100” are associated with the user ID “U001” in the battery DB 15 as shown in FIG. 4. Therefore, in this case, the specifying unit 12 specifies that the number of batteries BAT of a user with the user ID “U001” (that is, the user A) is a hundred.

For example, the specifying unit 12 specifies the number of batteries BAT of each user included in the batteries BAT charged by the charging device 20 by performing the above process for each user.

The derivation unit 13 derives, based on the number of batteries BAT of the one user specified by the specifying unit 12 and the number of batteries BAT that can be loaded on each transport device, a transport device required to transport the batteries BAT of the one user to a destination according to the one user. Specifically, the derivation unit 13 derives a transport device required to transport the batteries BAT of the one user to a destination according to the one user with reference to the number of batteries BAT of the one user specified by the specifying unit 12 and the transport device table 17.

For example, as described above, the specifying unit 12 specifies that the number of batteries BAT of the user with the user ID “U001” (that is, the user A) is a hundred. As shown in FIG. 6, in the transport device table 17, the upper limit number of batteries BAT that can be loaded on one trolley 51 is set to five. Therefore, in this case, the derivation unit 13 derives twenty trolleys 51 as the transport device required to transport the batteries BAT of the user with the user ID “U001” (100 batteries÷(5 batteries/1 trolley)=20 trolleys).

As described above, the derivation unit 13 derives, based on the number of the batteries BAT of one user specified by the specifying unit 12 and the upper limit number of the batteries BAT that can be loaded on the trolley 51, the number of the trolleys 51 required to transport the batteries BAT of the one user to a destination according to the one user, and thus the charging operator X can be notified of the number of trolleys 51 required to transport the charged batteries BAT of the one user to a destination.

In the present embodiment, the transport device for transporting the batteries BAT includes not only the trolley 51 but also the truck 52. Therefore, the derivation unit 13 derives not only the number of trolleys 51 but also the number of trucks 52 as the transport device required to transport the batteries BAT. Specifically, in this case, the derivation unit 13 further derives, based on the number of trolleys 51 required to load all the batteries BAT of one user and the upper limit number of trolleys 51 that can be loaded on one truck 52, the number of trucks 52 of the number required to load the trolleys 51 required to load all the batteries BAT of the one user.

For example, as described above, the number of trolleys 51 required to load all the batteries BAT of the user with the user ID “U001” is derived as twenty. As shown in FIG. 6, the upper limit number of trolleys 51 that can be loaded on one truck 52 is set to thirty. Therefore, in this case, the derivation unit 13 derives the number of trucks 52 required to transport the batteries BAT of the user with the user ID “U001” as one.

As described above, the derivation unit 13 derives, based on the number of trolleys 51 required to load all the batteries BAT of one user and the upper limit number of trolleys 51 that can be loaded on the truck 52, the number of trucks 52 required to load the trolleys 51 required to load all the batteries BAT of the one user, and thus the charging operator X can be notified of the number of trucks 52 required to transport the charged batteries BAT of the one user to a destination.

For example, the derivation unit 13 derives a transport device (here, the number of trolleys 51 and trucks 52) required to transport the batteries BAT of each user by performing the above process for each user. Then, the derivation unit 13 generates transport support information including information on the transport device required to transport the batteries BAT of each user derived through the above process.

The transport support information can be, for example, information representing, for each user, a transport device required to transport the batteries BAT of each user. For example, as described above, the number of trolleys 51 required to load all the batteries BAT of the user with the user ID “U001” is derived as twenty, and the number of trucks 52 required to load the twenty trolleys 51 is derived as one. Further, the number of trolleys 51 required to load all the batteries BAT of the user with the user ID “U002” is derived as ten, and the number of trucks 52 required to load the ten trolleys 51 is derived as one. In this case, the transport support information indicates that the number of trolleys 51 required to load the batteries BAT of the user with the user ID “U001” is twenty and the number of trucks 52 is one, and the number of trolleys 51 required to load the batteries BAT of the user with the user ID “U002” is ten and the number of trucks 52 is one. As a result, the charging operator X can be notified of the number of trolleys 51 and trucks 52 required to transport the batteries BAT of each user. The transport support information may further include other information in addition to the information described here.

The communication unit 11 outputs the transport support information generated by the derivation unit 13 to the terminal device 30. For example, the communication unit 11 outputs the transport support information to the terminal device 30 by transmitting the transport support information generated by the derivation unit 13 to the terminal device 30.

For example, the terminal device 30 that receives the transport support information from the battery transport support device 10 displays a transport support information display screen (to be described later) that displays the received transport support information. The charging operator X can easily know the number of trolleys 51 and trucks 52 required to transport the batteries BAT of each user by confirming the transport support information through the transport support information display screen. Therefore, the charging operator X can prepare the trolley 51 and the truck 52 required to transport the batteries BAT of each user to a destination, and can easily transport the batteries BAT to the destination according to each user after charging the batteries BAT of each user.

In the example described here, the specifying unit 12 specifies the number of batteries BAT of each user included in the batteries BAT charged by the charging device 20 and the derivation unit 13 derives, for each user, a transport device required to transport the batteries BAT of each user, but the present invention is not limited thereto.

For example, the specifying unit 12 may specify only the number of batteries BAT of a user specified by the charging operator X. Then, the derivation unit 13 may derive only a transport device required to transport the batteries BAT of the user specified by the charging operator X and generate transport support information. As a result, it is possible to output (for example, transmit) the transport support information desired by the charging operator X to the terminal device 30 while reducing the processing load of the battery transport support device 10.

The functions of the functional units, the communication unit 11, the specifying unit 12, and the derivation unit 13 described above can be implemented, for example, by a processor of the battery transport support device 10 executing a program stored in advance in a storage device such as a hard disk, or by an interface included in the battery transport support device 10.

[Example of Processing Performed by Devices of Battery Transport Support System]

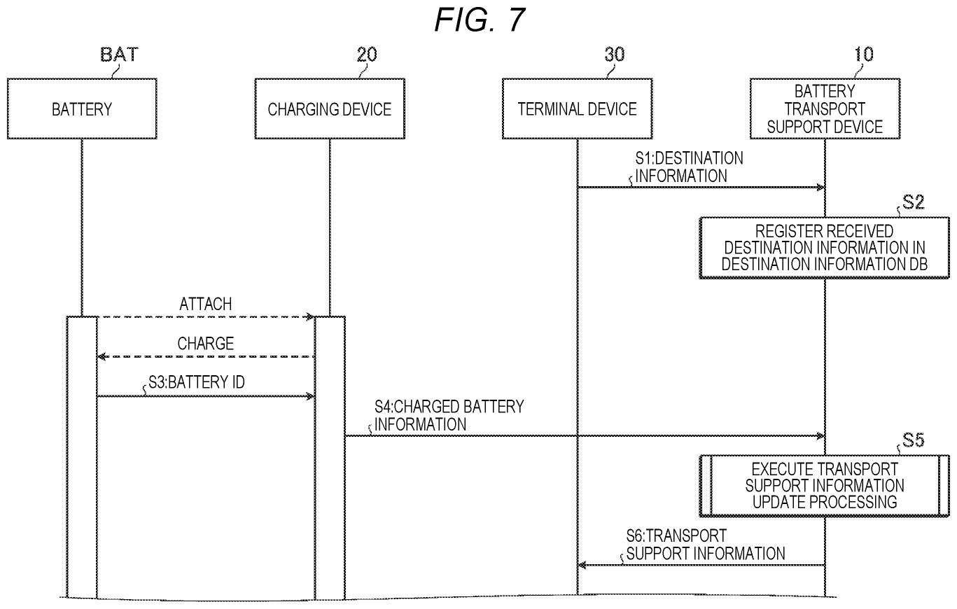

Next, an example of processing performed by devices of the battery transport support system 100 will be described with reference to FIG. 7.

As described above, when the user ID, the user name, the destination address, the transport deadline, and the like are input by the charging operator X, the terminal device 30 transmits the destination information indicating the input information to the battery transport support device 10 (step S1). The battery transport support device 10 that receives the destination information registers the destination information in the destination information DB 16 (step S2).

When the battery BAT is attached to the charging device 20 by the charging operator X, the charging of the battery BAT is started by the charging device 20. The battery BAT (battery IC) attached to the charging device 20 notifies the charging device 20 of a battery ID thereof and the like (step S3). The charging device 20 generates charged battery information including the battery ID and the like acquired from the battery BAT and transmits the generated charged battery information to the battery transport support device 10 (step S4).

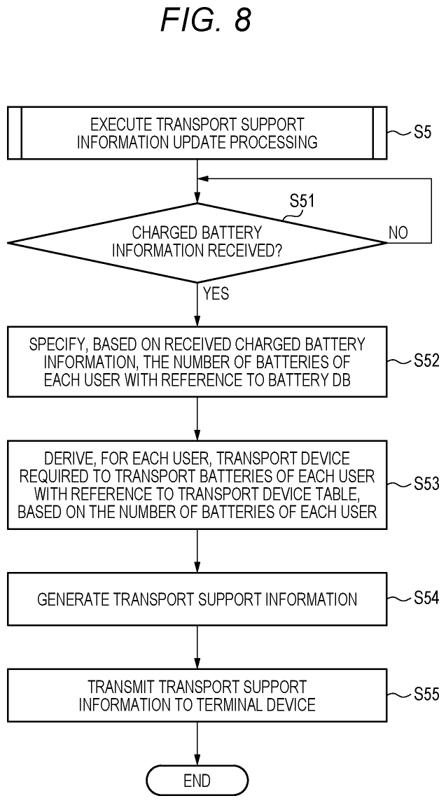

The battery transport support device 10 that receives the charged battery information executes transport support information update processing of generating transport support information (step S5), and transmits the transport support information generated by executing the transport support information update processing to the terminal device 30 (step S6). A specific example of the transport support information update processing will be described later with reference to FIG. 8 and the like.

Since the devices of the battery transport support system 100 perform the above processing, the charging operator X can obtain information necessary for transporting the battery BAT by attaching the battery BAT to the charging device 20. Therefore, the battery transport support system 100 enables the charging operator X to efficiently transport the battery BAT.

For example, it is preferable that the charging device 20 transmits the charged battery information to the battery transport support device 10 at a predetermined cycle (for example, at an interval of one minute), and in response to this, the battery transport support device 10 also executes the transport support information update processing at a predetermined cycle and transmits the transport support information to the terminal device 30. As a result, the transport support information can be automatically updated at a predetermined cycle, and the charging operator X can confirm the transport support information suitable for the situation at that time.

[Example of Transport Support Information Update Processing]

Next, an example of the transport support information update processing shown in step S5 of FIG. 7 will be described with reference to FIG. 8. The transport support information update processing is an example of a battery transport support method executed by the battery transport support device 10. A battery transport support program for causing the battery transport support device 10 to execute the transport support information update processing is stored in advance in, for example, a storage device (for example, the storage unit 14) of the battery transport support device 10.

In the transport support information update processing, the battery transport support device 10 waits until receiving the charged battery information from the charging device 20 (step S51: NO). When receiving the charged battery information (step S51: YES), the battery transport support device 10 specifies, based on the received charged battery information (that is, the charged battery information acquired from the charging device 20), the number of batteries BAT of each user included in the batteries BAT charged by the charging device 20 with reference to the battery DB 15 (step S52).

Next, the battery transport support device 10 derives, for each user, a transport device required to transport the batteries BAT of each user with reference to the transport device table 17, based on the number of batteries BAT of each user specified in step S52 (step S53). In step S53, the battery transport support device 10 derives, for example, the number of trolleys 51 and trucks 52 required to transport the batteries BAT of each user.

Then, the battery transport support device 10 generates transport support information including information on the transport device required to transport the batteries BAT of each user derived in step S53 (step S54), transmits (that is, outputs) the generated transport support information to the terminal device 30 (step S55), and ends the transport support information update processing.

[Example of Transport Support Information Display Screen of First Embodiment]

Next, an example of the transport support information display screen displayed by the terminal device 30 in the first embodiment will be described with reference to FIG. 9. When receiving transport support information from the battery transport support device 10, the terminal device 30 displays a transport support information display screen as shown in FIG. 9 on the display unit 30a.

The transport support information display screen displays the number of batteries BAT of each user included in the batteries BAT charged by the charging device 20, the number of trolleys 51 and trucks 52 as transport devices required to transport the batteries BAT of each user, a destination address as a destination according to each user, a transport deadline at which the batteries BAT are delivered to a destination addresses of each user, a departure deadline by which the charging operator X should depart from a business office (for example, the business office Y) to deliver the batteries BAT by the transport deadline, and charge completion time at which charging of the batteries BAT of each user is expected to be completed. That is, the battery transport support device 10 transmits, for example, transport support information including information indicating the above to the terminal device 30.

The departure deadline can be calculated based on, for example, a transport deadline and a distance from an address of the business office of the charging operator X to a destination address. The charge completion time can be calculated based on the SOC of each of the batteries BAT charged by the charging device 20 and the charging performance of the charging device 20. Since it is possible to prepare for transporting the batteries BAT (for example, load the batteries BAT on the trolley 51) after the charging of the batteries BAT is completed, the charge completion time can also be referred to as a transport preparation start possible time at which the transport preparation of the batteries BAT can be performed.

[Another Example of Transport Support Information Display Screen of First Embodiment]

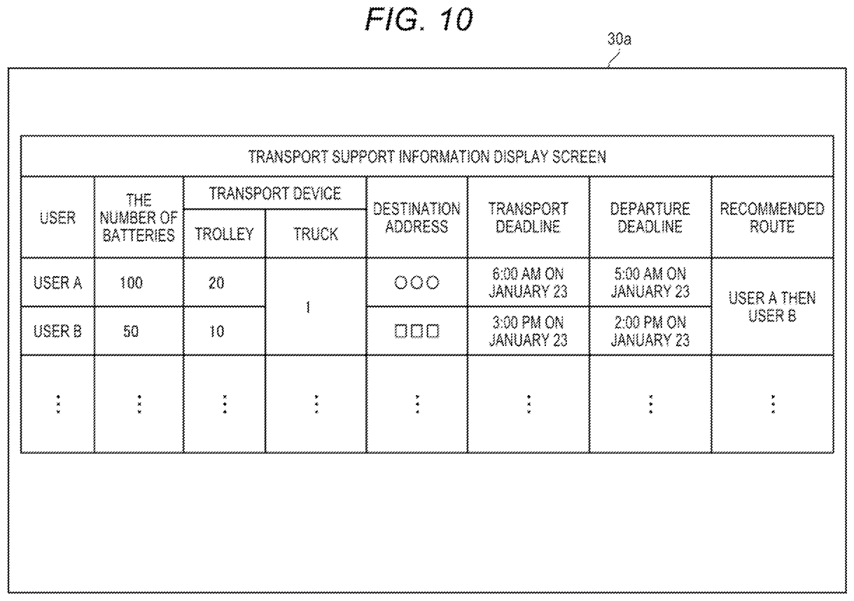

Next, another example of the transport support information display screen displaying transport support information in the first embodiment will be described with reference to FIG. 10. The transport support information display screen shown in FIG. 10 is different from the transport support information display screen shown in FIG. 9 in a display mode of a truck in a transport device and the display of a recommended route.

As described above, the upper limit number of trolleys 51 that can be loaded on the truck 52 is thirty. For example, when the number of trolleys 51 required to transport the batteries BAT of the user A is twenty and the number of trolleys 51 required to transport the batteries BAT of the user B is ten, all of thirty trolleys 51 can be loaded on one truck 52. Then, if the trolleys 51 on which the batteries BAT of the user A are loaded and the trolleys 51 on which the batteries BAT of the user B are loaded are loaded on one truck 52, it is possible to transport both the batteries BAT of the user A and the batteries BAT of the user B on one truck 52.

Here, in such a case, the battery transport support device 10 may generate transport support information including information indicating that the trolleys 51 on which the batteries BAT of the user A are loaded and the trolleys 51 on which the batteries BAT of the user B are loaded can be loaded on one truck 52 and transmit the transport support information to the terminal device 30. As a result, as shown in FIG. 10, the terminal device 30 can display a transport support information display screen indicating that the trolleys 51 on which the batteries BAT of the user A are loaded and the trolleys 51 on which the batteries BAT of the user B are loaded can be loaded on one truck 52.

In such a case, based on the address of the business office of the charging operator X, destination addresses of the user A and the user B, transport deadlines of the user A and the user B, map information, and the like, the battery transport support device 10 may derive a recommended route which is an appropriate transport route when the batteries BAT of the user A and the batteries BAT of the user B are transported by one truck 52, generate transport support information including information on the recommended route, and transmit the transport support information to the terminal device 30. As a result, as shown in FIG. 10, the terminal device 30 can display a transport support information display screen including the information on the recommended route. In the example shown in FIG. 10, since the transport deadline of the user A is earlier than the transport deadline of the user B, recommended route prompting to transport the batteries BAT of the user B after transporting the batteries BAT of the user A is displayed.

[Battery Transport Support System of Second Embodiment]

Next, a second embodiment of the present invention will be described. In the following second embodiment, the parts different from those of the first embodiment will be mainly described, and the description of the parts similar to those of the first embodiment will be appropriately omitted or simplified.

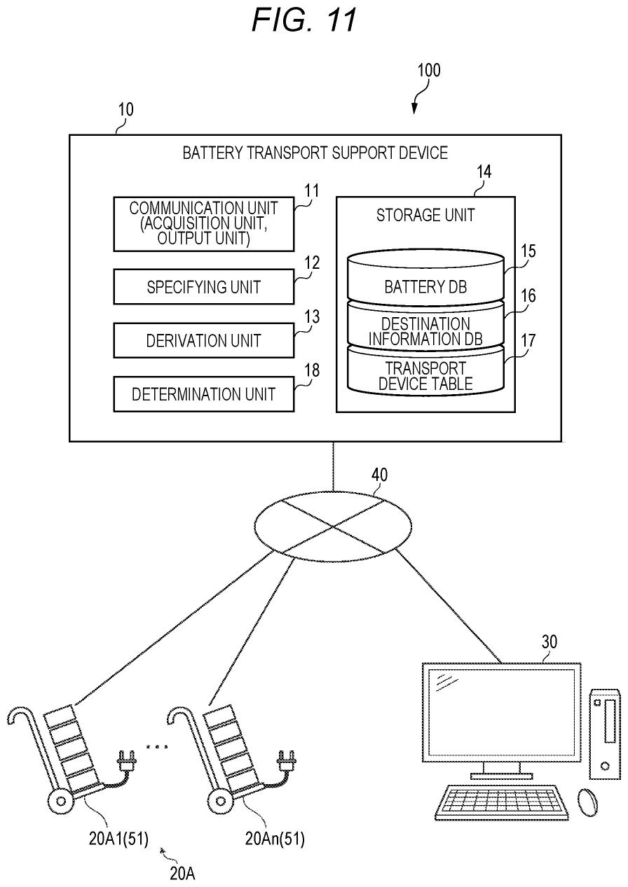

As shown in FIG. 11, the battery transport support system 100 of the second embodiment is different from the battery transport support system 100 of the first embodiment in that the battery transport support system 100 of the second embodiment includes n (for example, n is a natural number of 2 or more) charging devices 20A from a charging device 20A1 to a charging device 20An. Here, each charging device 20A is a trolley 51 configured to load up to a predetermined upper limit number (here, five as an example) of batteries BAT and charge the loaded batteries BAT.

In the battery transport support system 100 of the first embodiment, the charging operator X needs to remove the batteries BAT from the charging device 20 and load the batteries BAT on the trolley 51 after charging the batteries BAT by the charging device 20. On the other hand, in the battery transport support system 100 of the second embodiment, since the charging device 20A is also the trolley 51, the charging operator X can charge the batteries BAT by the charging device 20A and then load the charging device 20A on the truck 52. Therefore, it is possible to reduce the time and effort of the charging operator X such as removing the batteries BAT from the charging device 20 and load the batteries BAT on the trolley 51 again, and efficiently transport the batteries BAT.

In the second embodiment, for example, when the battery BAT is loaded and charging of the battery BAT is started, each charging device 20A generates charged battery information including a charging device ID of the charging device 20A and a battery ID of the battery BAT loaded on the charging device 20A, and transmits the generated charged battery information to the battery transport support device 10. Then, for example, the battery transport support device 10 receives the charged battery information transmitted from each charging device 20A by the communication unit 11, thereby acquiring the charged battery information including the battery ID of the battery BAT charged by each charging device 20A (that is, loaded on each charging device 20A).

In the second embodiment, as in the first embodiment, the specifying unit 12 specifies the number of batteries BAT of one user included in the batteries BAT charged by the charging devices 20A from the charging device 20A1 to the charging device 20An. Further, the specifying unit 12 also specifies the charging device 20A on which the batteries BAT of the one user are loaded based on the received charged battery information with reference to the storage unit 14. Specifically, the specifying unit 12 specifies the charging device 20A on which the batteries BAT of the one user are loaded with reference to the battery DB 15 and the charging device ID and the battery ID included in the received charged battery information.

For example, the charged battery information received from the charging device 20A1 with a charging device ID “C001” includes battery IDs “B001” to “B005”, and the charged battery information received from the charging device 20A2 with a charging device ID “C002” includes battery IDs “B006” to “B010”. In this case, the specifying unit 12 specifies the charging device 20A1 of “C001” and the charging device 20A2 of “C002” as the charging device 20A on which the batteries BAT of a user with a user ID “U001” are loaded.

In the second embodiment, as in the first embodiment, the derivation unit 13 derives, based on the number of batteries BAT of the one user specified by the specifying unit 12 and the number of batteries BAT that can be loaded on each transport device, a transport device required to transport the batteries BAT of the one user to a destination according to the one user. Further, the derivation unit 13 generates transport support information including identification information (for example, the charging device ID) of the charging device 20A on which the batteries BAT of the one user specified by the specifying unit 12 are loaded.

The communication unit 11 outputs (for example, transmits) the transport support information generated by the derivation unit 13 to the terminal device 30. That is, in the second embodiment, the communication unit 11 functions as an output unit that outputs, to the terminal device 30, the transport support information including the identification information of the charging device 20A on which the batteries BAT of the one user are loaded.

[Example of Transport Support Information Display Screen of Second Embodiment]

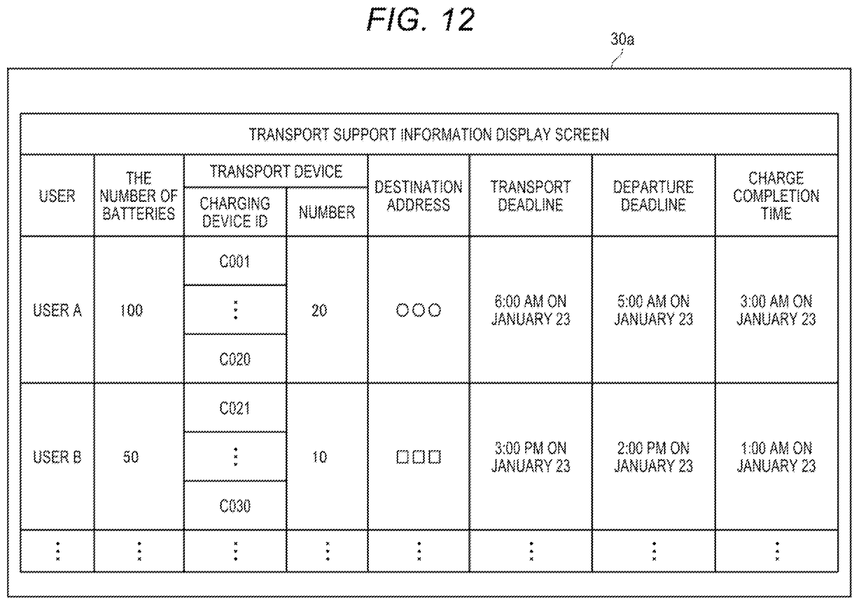

Next, an example of a transport support information display screen displayed by the terminal device 30 in the second embodiment will be described with reference to FIG. 12. The transport support information display screen of the second embodiment is different from the transport support information display screen of the first embodiment in that the information on a charging device ID is included in the information on a transport device.

In the example shown in FIG. 12, the user A and charging device IDs “C001” to “C020” are displayed in association with each other. Therefore, by checking the transport support information display screen, the charging operator X can easily know that the charging devices 20A corresponding to the charging device IDs from “C001” to “C020” may be transported to transport the batteries BAT of the user A. Similarly, the charging operator X can easily know that the charging devices 20A corresponding to charging device IDs “C021” to “C030” may be transported to transport the batteries BAT of the user B.

As described above, according to the battery transport support system 100 of the second embodiment, the charging operator X can easily determine which charging device 20A (that is, the trolley 51) should be transported to transport the batteries BAT of each user.

Incidentally, in the second embodiment, as a basic rule of the charging operator X, the batteries BAT are classified for each user and loaded on the charging device 20A. In other words, one charging device 20A is loaded with only the batteries BAT of one user. According to such a basic rule, erroneous transport, such as transport of the batteries BAT of one user to a destination of another user is prevented. However, due to a mistake by the charging operator X, a situation may occur in which the batteries BAT of one user are also loaded on the charging device 20A on which the batteries BAT of another user are loaded. As a result, the batteries BAT of one user may be erroneously transported to a destination of another user.

To avoid such a situation from occurring, the battery transport support device 10 of the second embodiment includes, for example, a determination unit 18 as shown in FIG. 11. Here, the determination unit 18 determines, based on the received charged battery information, whether the batteries BAT of one user are also loaded on the charging device 20A on which the batteries BAT of another user are loaded with reference to the storage unit 14.

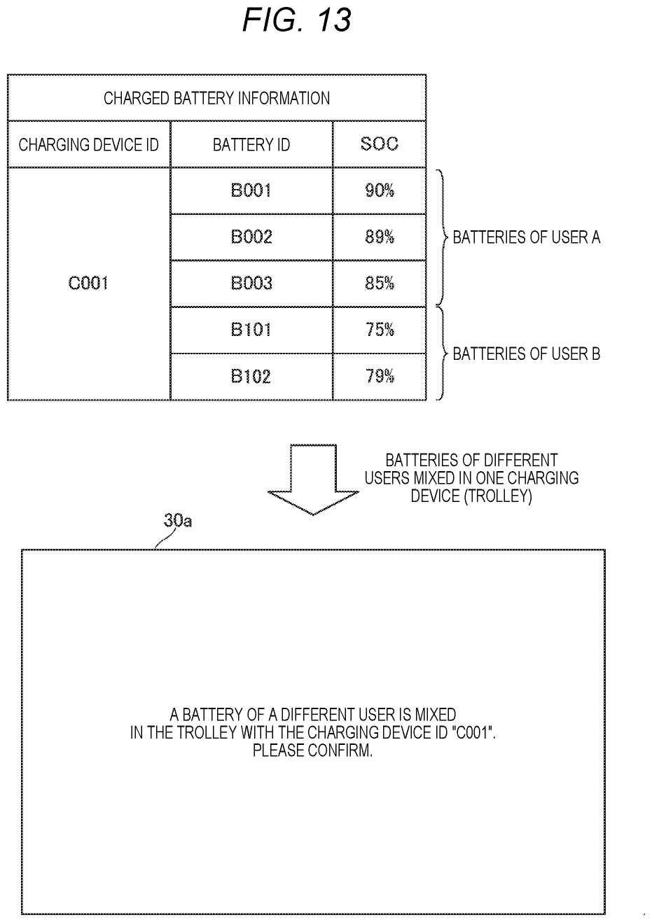

For example, as shown in FIG. 13, the charged battery information received from the charging device 20A1 with the charging device ID “C001” includes the battery IDs “B001”, “B002”, “B003”, “B101”, and “B102”. Here, the batteries BAT “B001”, “B002”, and “B003” are the batteries BAT of the user A, and the batteries BAT “B101” and “B102” are the batteries BAT of the user B (see FIG. 4).

Therefore, in this case, the determination unit 18 determines that not only the batteries BAT of one user (here, the user A) but also the batteries BAT of another user (here, the user B) are loaded on the charging device 20A1 with the charging device ID “C001”, that is, the batteries BAT of a plurality of users are mixed. When the determination unit 18 determines that the batteries BAT of another user are also loaded, the communication unit 11 outputs (for example, transmits), to the terminal device 30, alert information including the identification information (for example, the charging device ID) of the charging device 20A on which the batteries BAT of another user are also loaded.

For example, as shown in FIG. 13, the terminal device 30 that receives the alert information displays a message “A Battery of a different user is mixed in the trolley with the charging device ID “C001”. Please confirm.” on the display unit 30a. That is, the alert information is for information displaying such a message on the terminal device 30, for example. As a result, the charging operator X can be notified of a charging device 20A on which the batteries BAT of a plurality of users are mixed and loaded. Therefore, it is possible to urge the charging operator X to confirm the batteries BAT loaded on the charging device 20A, and to prevent erroneous transport in which the batteries BAT of one user are transported to a destination of another user.

As described above, according to the battery transport support system 100, the battery transport support device 10, the battery transport support method, and the battery transport support program of the embodiments of the present invention, the charging operator X who charges the batteries BAT of each user and transports the batteries BAT to a destination corresponding to each user can efficiently transport the batteries BAT of each user to the destination according to each user.

Although the embodiments of the present invention have been described above, the present invention is not limited to the embodiments, and various modifications and substitutions can be made without departing from the gist of the present invention.

For example, in the embodiments described above, an example has been described in which a user who uses the charging service of the charging operator X is an operator who works in an apartment complex or the like. The user may be, for example, a person who has the authority to use the charging service of the charging operator X, regardless of an occupation or the like of the user.

In the above embodiments, an example in which the trolley 51 or the truck 52 is used as a transport device that transports the batteries BAT has been described, but the present invention is not limited thereto. The transport device may be, for example, any device capable of directly or indirectly loading the batteries BAT, and may be, for example, an aircraft including an unmanned aerial vehicle called a drone, a ship, a motorcycle, or the like.

In the above embodiments, an example in which two types of transport devices, the trolley 51 and the truck 52 are provided as the transport devices for transporting the batteries BAT has been described, but the present invention is not limited thereto. One type of transport device may be used, or three or more types may be used.

In the present specification, at least the following matters are described. Corresponding constituent elements and the like in the embodiments described above are shown in parentheses, but the present invention is not limited thereto.
(1) A battery transport support system (battery transport support system 100) for supporting battery transport by a charging operator who charges batteries (batteries BAT) of each user and transports the batteries to a destination according to each user, the battery transport support system including:
a charging device (charging device 20) configured to charge the attached batteries and acquire identification information of the batteries from the batteries; and
a battery transport support device (battery transport support device 10) configured to acquire, from the charging device, charged battery information including the identification information of the batteries charged by the charging device, in which
the battery transport support device includes:
   a specifying unit (specifying unit 12) configured to specify, based on the charged battery information acquired from the charging device, the number of batteries of one user included in the batteries charged by the charging device with reference to a storage unit (storage unit 14, battery DB 15) that stores identification information of each user and identification information of the batteries of each user in association with each other,
   a derivation unit (derivation unit 13) configured to derive, based on the number of batteries of the one user and the number of batteries capable of being loaded on each transport device, a transport device (trolley 51, truck 52) required to transport the batteries of the one user to a destination according to the one user, and
   an output unit (communication unit 11) configured to output, to a terminal device (terminal device 30) of the charging operator, transport support information including information on the transport device required to transport the batteries to the destination according to the one user.

According to (1), as the batteries of the one user are charged by the charging device, the transport device required to transport the batteries of the user to the destination can be derived, and the transport support information including the information on the required transport device can be output to the terminal device of the charging operator. As a result, the charging operator can be notified of the transport device required to transport the charged batteries of the one user to the destination. Therefore, the charging operator can prepare the transport device required to transport the charged batteries of the one user to the destination, and can easily and efficiently transport the batteries of the one user to the destination after charging.
(2) The battery transport support system according to (1), in which
the transport device includes a first transport device (trolley 51) configured to load up to a predetermined upper limit number of the batteries, and
the derivation unit derives, as the required transport device, the number of the first transport devices required to load all the batteries of the one user, based on the number of the batteries of the one user and the upper limit number.

According to (2), it is possible to derive the number of the first transport devices required to load all the batteries of the one user based on the number of the batteries of the one user and the upper limit number of batteries that can be loaded on the first transport device. As a result, the charging operator can be notified of the number of the first transport devices required to transport the charged batteries of the one user to the destination.
(3) The battery transport support system according to (2), in which
the transport device further includes a second transport device (truck 52) configured to load up to a predetermined upper limit number of the first transport devices, and
the derivation unit further derives, as the required transport device, the number of the second transport devices required to load the first transport devices of the number required to load all the batteries of the one user, based on the number of the first transport devices required to load all the batteries of the one user and the upper limit number.

According to (3), it is possible to derive, based on the number of the first transport devices required to load all the batteries of the one user and the upper limit number of the first transport devices that can be loaded on the second transport device, the number of the second transport devices required to load the first transport devices of the number required to load all the batteries of the one user. As a result, the charging operator can be notified of the number of the second transport devices required to transport the charged batteries of the one user to the destination.
(4) The battery transport support system according to (2) or (3), in which the charging device (charging device 20A) is the first transport device configured to charge the loaded batteries.

According to (4), since the charging device is the first transport device, it is possible to reduce the time and effort of the charging operator who reloads the batteries on the first transport device for transport after charging.
(5) The battery transport support system according to (4), in which
the battery transport support device acquires the charged battery information further including identification information on the charging device from the charging device,
the specifying unit further specifies, based on the charged battery information, the charging device on which the batteries of the one user are loaded with reference to the storage unit, and
the output unit outputs, to the terminal device, the transport support information including the identification information of the charging device on which the batteries of the one user are loaded.

According to (5), it is possible to output, to the terminal device of the charging operator, the transport support information including the identification information of the charging device on which the batteries of the one user are loaded. As a result, the charging operator can be notified of the charging device on which the batteries of the one user are loaded. Therefore, the charging operator can easily determine which charging device (that is, the first transport device) should be transported to transport the batteries of the one user.
(6) The battery transport support system according to (5), in which
the battery transport support device further includes a determination unit (determination unit 18) that determines, based on the charged battery information, whether a battery of another user is also loaded on the charging device on which the batteries of the one user are loaded with reference to the storage unit, and
when the determination unit determines that the battery of another user is also loaded, the output unit outputs, to the terminal device, alert information including identification information of the charging device on which the battery of the another user is also loaded.

According to (6), when it is determined that the battery of another user is also loaded on the charging device on which the batteries of the one user are loaded, the alert information including the identification information of the charging device on which the battery of another user is also loaded can be output to the terminal device of the charging operator. As a result, the charging operator can be notified of the charging device on which the batteries of a plurality of users are mixed and loaded. Therefore, it is possible to urge the charging operator to confirm the batteries loaded on the charging device, and to prevent erroneous transport in which batteries of one user are transported to a destination of another user.
(7) A battery transport support device (battery transport support device 10) for supporting battery transport by a charging operator who charges batteries of each user and transports the batteries (batteries BAT) to a destination according to each user, the battery transport support device being configured to acquire, from a charging device (charging device 20) that charges the attached batteries and acquires identification information of the batteries from the batteries, charged battery information including the identification information of the batteries charged by the charging device, the battery transport support device including:
a specifying unit (specifying unit 12) configured to specify, based on the charged battery information acquired from the charging device, the number of batteries of one user included in the batteries charged by the charging device with reference to a storage unit (storage unit 14, battery DB 15) that stores identification information of each user and identification information of the batteries of each user in association with each other;
a derivation unit (derivation unit 13) configured to derive, based on the number of the batteries of one user and the number of batteries capable of being loaded on each transport device, a transport device (trolley 51, truck 52) required to transport the batteries of the one user to a destination according to the one user; and
an output unit (communication unit 11) configured to output, to a terminal device (terminal device 30) of the charging operator, transport support information including information on the transport device required to transport the batteries to the destination according to the one user.

According to (7), as the batteries of the one user are charged by the charging device, the transport device required to transport the batteries of the user to the destination can be derived, and the transport support information including the information on the required transport device can be output to the terminal device of the charging operator. As a result, the charging operator can be notified of the transport device required to transport the charged batteries of the one user to the destination. Therefore, the charging operator can prepare the transport device required to transport the charged batteries of the one user to the destination, and can easily and efficiently transport the batteries of the one user to the destination after charging.
(8) A battery transport support method for supporting battery transport by a charging operator who charges batteries (batteries BAT) of each user and transports the batteries to a destination according to each user, the method including:
a computer (battery transport support device 10) configured to acquire, from a charging device (charging device 20) that charges the attached batteries and acquires identification information of the batteries from the batteries, charged battery information including the identification information of the batteries charged by the charging device executing the processing of:
specifying, based on the charged battery information acquired from the charging device, the number of batteries of one user included in the batteries charged by the charging device with reference to a storage unit (storage unit 14, battery DB 15) that stores identification information of each user and identification information of the batteries of each user in association with each other (step S52);
deriving, based on the number of batteries of the one user and the number of batteries capable of being loaded on each transport device, a transport device (trolley 51, truck 52) required to transport the batteries of the one user to a destination according to the one user (step S53); and
outputting, to a terminal device (terminal device 30) of the charging operator, transport support information including information on the transport device required to transport the batteries to the destination according to the one user (step S55).

According to (8), as the batteries of the one user are charged by the charging device, the transport device required to transport the batteries of the user to the destination can be derived, and the transport support information including the information on the required transport device can be output to the terminal device of the charging operator. As a result, the charging operator can be notified of the transport device required to transport the charged batteries of the one user to the destination. Therefore, the charging operator can prepare the transport device required to transport the charged batteries of the one user to the destination, and can easily and efficiently transport the batteries of the one user to the destination after charging.
(9) A battery transport support program for supporting battery transport by a charging operator who charges batteries (batteries BAT) of each user and transports the batteries to a destination according to each user, the program causing a computer (battery transport support device 10) configured to acquire, from a charging device (charging device 20) that charges the attached batteries and acquires identification information of the batteries from the batteries, charged battery information including the identification information of the batteries charged by the charging device to execute processing including;
specifying, based on the charged battery information acquired from the charging device, the number of batteries of one user included in the batteries charged by the charging device with reference to a storage unit (storage unit 14, battery DB 15) that stores identification information of each user and identification information of the batteries of each user in association with each other (step S52);
deriving, based on the number of batteries of the one user and the number of batteries capable of being loaded on each transport device, a transport device (trolley 51, truck 52) required to transport the batteries of the one user to a destination according to the one user (step S53); and
outputting, to a terminal device (terminal device 30) of the charging operator, transport support information including information on the transport device required to transport the batteries to the destination according to the one user (step S55).

According to (9), as the batteries of the one user are charged by the charging device, the transport device required to transport the batteries of the user to the destination can be derived, and the transport support information including the information on the required transport device can be output to the terminal device of the charging operator. As a result, the charging operator can be notified of the transport device required to transport the charged batteries of the one user to the destination. Therefore, the charging operator can prepare the transport device required to transport the charged batteries of the one user to the destination, and can easily and efficiently transport the batteries of the one user to the destination after charging.

### REFERENCE SIGNS LIST

10 battery transport support device
11 communication unit (output unit)
12 specifying unit
13 derivation unit
14 storage unit
15 battery DB
16 destination information DB
17 transport device table
18 determination unit
20 charging device
20A charging device (trolley, first transport device)
30 terminal device
40 network
51 trolley (first transport device)
52 truck (second transport device)
100 battery transport support system
BAT Battery

1. A battery transport support system for supporting battery transport by a charging operator who charges batteries of each user and transports the batteries to a destination according to each user, the battery transport support system comprising:
a charging device configured to charge the attached batteries and acquire identification information of the batteries from the batteries; and
a battery transport support device configured to acquire, from the charging device, charged battery information including the identification information of the batteries charged by the charging device, wherein
the battery transport support device includes:
a specifying unit configured to specify, based on the charged battery information acquired from the charging device, the number of batteries of one user included in the batteries charged by the charging device with reference to a storage unit that stores identification information of each user and identification information of the batteries of each user in association with each other,
a derivation unit configured to derive, based on the number of batteries of the one user and the number of batteries capable of being loaded on each transport device, a transport device required to transport the batteries of the one user to a destination according to the one user, and
an output unit configured to output, to a terminal device of the charging operator, transport support information including information on the transport device required to transport the batteries to the destination according to the one user.

2. The battery transport support system according to claim 1, wherein
the transport device includes a first transport device configured to load up to a predetermined upper limit number of the batteries, and
the derivation unit derives, as the required transport device, the number of the first transport devices required to load all the batteries of the one user, based on the number of the batteries of the one user and the upper limit number.

3. The battery transport support system according to claim 2, wherein
the transport device further includes a second transport device configured to load up to a predetermined upper limit number of the first transport devices, and
the derivation unit further derives, as the required transport device, the number of the second transport devices required to load the first transport devices of the number required to load all the batteries of the one user, based on the number of the first transport devices required to load all the batteries of the one user and the upper limit number.

4. The battery transport support system according to claim 2, wherein
the charging device is the first transport device configured to charge the loaded batteries.

5. The battery transport support system according to claim 4, wherein
the battery transport support device acquires the charged battery information further including identification information on the charging device from the charging device,
the specifying unit further specifies, based on the charged battery information, the charging device on which the batteries of the one user are loaded with reference to the storage unit, and
the output unit outputs, to the terminal device, the transport support information including the identification information of the charging device on which the batteries of the one user are loaded.

6. The battery transport support system according to claim 5, wherein
the battery transport support device further includes a determination unit that determines, based on the charged battery information, whether a battery of another user is also loaded on the charging device on which the batteries of the one user are loaded with reference to the storage unit, and
when the determination unit determines that the battery of another user is also loaded, the output unit outputs, to the terminal device, alert information including identification information of the charging device on which the battery of the another user is also loaded.

7. A battery transport support device for supporting battery transport by a charging operator who charges batteries of each user and transports the batteries to a destination according to each user, the battery transport support device being configured to acquire, from a charging device that charges the attached batteries and acquires identification information of the batteries from the batteries, charged battery information including the identification information of the batteries charged by the charging device, the battery transport support device comprising:
a specifying unit configured to specify, based on the charged battery information acquired from the charging device, the number of batteries of one user included in the batteries charged by the charging device with reference to a storage unit that stores identification information of each user and identification information of the batteries of each user in association with each other;
a derivation unit configured to derive, based on the number of the batteries of one user and the number of batteries capable of being loaded on each transport device, a transport device required to transport the batteries of the one user to a destination according to the one user; and
an output unit configured to output, to a terminal device of the charging operator, transport support information including information on the transport device required to transport the batteries to the destination according to the one user.

8. A battery transport support method for supporting battery transport by a charging operator who charges batteries of each user and transports the batteries to a destination according to each user, the method comprising:
a computer configured to acquire, from a charging device that charges the attached batteries and acquires identification information of the batteries from the batteries, charged battery information including the identification information of the batteries charged by the charging device executing the processing of:
specifying, based on the charged battery information acquired from the charging device, the number of batteries of one user included in the batteries charged by the charging device with reference to a storage unit that stores identification information of each user and identification information of the batteries of each user in association with each other;
deriving, based on the number of batteries of the one user and the number of batteries capable of being loaded on each transport device, a transport device required to transport the batteries of the one user to a destination according to the one user; and
outputting, to a terminal device of the charging operator, transport support information including information on the transport device required to transport the batteries to the destination according to the one user.

9. A non-transitory computer-readable storage medium storing a battery transport support program for supporting battery transport by a charging operator who charges batteries of each user and transports the batteries to a destination according to each user, the program causing a computer configured to acquire, from a charging device that charges the attached batteries and acquires identification information of the batteries from the batteries, charged battery information including the identification information of the batteries charged by the charging device to execute processing comprising:
specifying, based on the charged battery information acquired from the charging device, the number of batteries of one user included in the batteries charged by the charging device with reference to a storage unit that stores identification information of each user and identification information of the batteries of each user in association with each other;
deriving, based on the number of batteries of the one user and the number of batteries capable of being loaded on each transport device, a transport device required to transport the batteries of the one user to a destination according to the one user; and
outputting, to a terminal device of the charging operator, transport support information including information on the transport device required to transport the batteries to the destination according to the one user.
